(19) United States
(12) Patent Application Publication
(10) Pub. No.: US 2026/0185627 A1
(43) Pub. Date: Jul. 2, 2026

(54) ACTUATOR SYSTEM HAVING A MODULAR FIXATION

(71) Applicant: BELIMO Holding AG, Hinwil (CH)

(72) Inventors: Urs NIEDERHAUSER, Pfungen (CH); Patrick SCHMIDHEINY, Wetzikon (CH); Aaron DÜRLER, Bertschikon (CH); Stephan GRÜNIGER, Gossau (CH)

(21) Appl. No.: 19/551,506

(22) Filed: Feb. 26, 2026

Related U.S. Application Data
(63) Continuation-in-part of application No. 18/555,374.

(30) Foreign Application Priority Data
Apr. 13, 2021 (CH) 00378/21

(51) Int. Cl. F16K 31/04; F16K 27/02

(52) U.S. Cl. CPC F16K 31/047; F16K 27/0218

(57) ABSTRACT

An actuator system is provided for operating a flow regulating element, e. g. a flap or a valve shutter for regulating a fluid flow in a fluid transportation pipe. The actuator system may include an actuator having an actuating motor coupled to a pivotable shaft of the flow regulating element which projects from the wall of the pipe. The actuator system has at least one attachment component for attachment of the attachment component to the wall of the fluid transportation pipe. The actuator and the attachment component(s) are configured as a modular system.

### CROSS-REFERENCES

The following applications and materials are incorporated herein by reference, in their entireties, for all purposes: U.S. patent application Ser. No. 18/555,374, filed Oct. 13, 2023. However, such material is only incorporated to the extent that no conflict exists between the incorporated material and the statements and drawings set forth herein. In the event of any such conflict, including any conflict in terminology, the present disclosure is controlling.

### TECHNICAL FIELD

The present disclosure relates to an actuator system for operating at least one flow regulating element to regulate a fluid flow of a fluid transportation pipe.

### BACKGROUND

In the field of heating, ventilation and air-conditioning systems, called HVAC systems, in buildings, in particular residential buildings, office buildings, commercial buildings and industrial buildings, automatic fluid flow regulation has become more and more important. To this end, a plurality of sensors and actuators for regulating the flow are used, controlled by automatic centrally or decentrally arranged control devices. Actuating motors, sensors, like pressure sensors and temperature sensors, and regulators are usually combined in one compact unit.

Pivotable fluid regulating elements, like shutters or flaps, are important components for automatic fluid flow control systems. The volumetric flow is measured using a suitable sensor, and the measured values are forwarded to an electronics system. In order to pivot the fluid regulating elements, actuator motors operate the flow regulating elements. Due to relatively high torque generated in this process the connection between the actuators and the respective fluid pipe has to be strong and reliable. Particularly, the actuating motor has to be prevented from twisting on account of the exerted torque. On the other hand, mounting the actuator to the pipe has to be kept as simple as possible. Furthermore, when the motor is firmly coupled to a fluid regulating element, it may be necessary to absorb, in addition to a torque, any eccentricity of the rotating shaft axis.

The patent U.S. Pat. No. 8,061,684 B2 discloses an anti-twist device which permits a corresponding linear movement in the longitudinal direction but prevents twisting of the actuating motor. However, mounting the actuator to a pipe is still complex, and the actuators as well as the attachment components have to be adapted to each other specifically.

### SUMMARY

It is an object of the present disclosure to provide an actuator system for operating at least one flow regulating element to regulate a fluid flow of a fluid transportation pipe, which provide a secure and reliable connection between the actuator system and the pipe, while reducing the complexity of the mounting process. An actuator system for operating at least one flow regulating element, e.g. a flap, a valve shutter, etc., to regulate a fluid flow of a fluid transportation pipe according to the present disclosure, comprises: an actuator having an actuating motor coupled to a pivotable shaft of the flow regulating element of the fluid transportation pipe, and an actuator housing, wherein the actuating motor is connected to the actuator housing; at least one attachment component for attachment of the attachment component to a wall of the fluid transportation pipe; wherein the actuator housing comprises a connecting port for connecting the attachment component to the housing.

The actuator system for operating a flow regulating element to regulate a fluid flow of a fluid transportation pipe according to the present disclosure comprises: an actuator having an actuating motor coupled to a pivotable shaft of the flow regulating element, and an actuator housing having a first longitudinal end and an opposite second longitudinal end, wherein the actuating motor is connected to the actuator housing; and at least one attachment component for attachment of the actuator housing to a wall of the fluid transportation pipe, wherein the attachment component is selected from a set of attachment components, the set comprising a first attachment component and a second attachment component; wherein the actuator housing comprises a first connecting port at the first longitudinal end and a second connecting port at the second longitudinal end, the first connecting port being configured to connect the first attachment component and the second connecting port to connect the second attachment component to the housing by a clamping connection comprising two flexible arms configured to be inserted in corresponding receptacles of the connecting ports; and wherein the least one attachment component is arranged at one of the opposite longitudinal ends of the actuator housing preventing rotation of actuator housing around an axis of the pivotable shaft and a longitudinal movement along the axis.

Particularly, the actuator system is a modular system comprising the actuator and the first and the second attachment component. Conventional actuators and gearboxes differ in their size and configuration, e.g. in the size of the base plate and the configuration of the housing. Therefore, a large variety of actuator systems for fluid control are available, all of them having different and even customer-specific attachment systems for fixing them to the place of installation, e.g. a fluid pipe. Providing attachment components and the actuator as separate, modular components reduces the variety of connection concepts as well as variants of the base module. This disclosure proposes a simplified mounting process, namely, mounting a fixing element like a screw to the pipe, then fixing the actuator and the attachment element, which is adapted to both the fixing element and the actuator housing, to the pre-mounted fixing element. This provides that no more accessories (e.g. anti-twist devices, further screws) are required that could be lost during the mounting process. In a particular embodiment of the present disclosure the fixing element may be pre-mounted.

Another advantage is that the solution is backwards compatible and still works with existing anti-rotation devices.

It is preferred that the at least one attachment component is detachably fixable to a respective connection port of the actuator housing.

In a preferred embodiment of the present disclosure the attachment component is connectable to the connecting port by a clamping connection. The attachment component connectable to the connecting port by a clamping connection may be snapped into place and then fixed to pre-mounted fixing elements (e. g. screws) already pre-mounted in the place of installation.

The clamping connection may comprise at least two flexible arms to be insertable in corresponding receptacles of the connecting port.

It is preferred that the system comprises a locking element for locking the connection between the connecting port and the attachment component. Particularly, the locking element may be inserted in a space between the clamping arms to prevent movement of engagement lugs of the clamping arms within corresponding clamping grooves provided in the port of the housing.

In a particular embodiment the at least one attachment component comprises a slot configured to receive a fixing element which is fixed in the wall of the fluid transportation pipe. The fixing element may be a screw, a bolt or any other stud that can be mounted, especially pre-mounted, in the wall of the pipe. The attachment component comprising a longitudinal slot or clearance that may be open at one end of the slot and clearance, respectively, is particularly useful for applications wherein the actuator system has to absorb or compensate for eccentricity of the rotation of the shaft of the flow regulating element. The slot allows the housing to move (linearly) along a longitudinal axis relative to the pipe, and therefore tensions in the attachment components (or other components of the system) can be avoided. In other words, even in case of an eccentricity of the rotating shaft of the fluid flow regulating element eccentricity can be compensated for. The degree of eccentricity depends on the diameter of the rotating shaft which is mounted to a universal adapter that can accommodate multiple diameters. The smaller the diameter the greater the eccentricity will be. Unprecise mounting may be another source for excentricity.

In this case, one side of the actuator is fixed with play to allow longitudinal movement, but the attachment element prevents rotation around the shaft of the fluid regulating element. Furthermore, this construction allows assembly of an actuator to a pipe in short time, as only one screw that is already pre-assembled, is involved. Thus, installation is much easier, even overhead.

In this application the terms “above,” “over,” “below,” “under,” “lateral,” “axial”, “longitudinal”, etc., should not necessarily be understood as absolute positions and directions, respectively, in free space, but rather as descriptions of the relationships between the components. Generally, “below” refers to the side of the actuator housing facing the fluid line in a mounted state. “Above” or “over” indicates an arrangement on the side of the actuator housing facing away from the fluid line. A “longitudinal plane” refers to a plane extending vertically upwards from the underside of the actuator housing. The “longitudinal” plane extends along the tube, pipe or duct on which the housing is to be mounted. Typically, the longitudinal plane essentially forms a plane of symmetry of the actuator housing. In this sense, the longitudinal plane may be referred to as the central longitudinal plane. That is, the longitudinal plane extends from a front side or front end of the housing to a rear side or rear end of the housing and vertically upwards from the base of the housing. “Lateral” indicates a position within a distance perpendicular to the longitudinal plane. A “longitudinal axis” (with longitudinal direction) is an axis that lies in the longitudinal plane and extends along or parallel to a bottom surface of the housing. The direction of the rotation/drive axis of the drive shaft of the actuator is defined as axial direction. Usually, the axial direction is perpendicular to the bottom surface of the housing and lies in a longitudinal plane as defined above. The longitudinal axis or longitudinal direction is perpendicular to the axial direction (axis of the drive shaft of the actuator).

The attachment component may comprise a fixing portion to be inserted in a bore provided in the wall of the fluid transportation pipe within a distance from the pivotable shaft of the flow regulating element. In this embodiment, the attachment component has a fixing portion integrally formed or fixed thereto, which replaces the separate fixing element. The fixing portion may e.g. be a bolt or a spring element extending from the body of the attachment component towards the wall of the pipe. In the mounting process, a bore could be formed in the pipe before fixing the actuator system to the pipe. Also in this embodiment the number of components is small and mounting even with just one hand is possible.

The actuator system may comprise a fixing element to be fixed to the wall of the fluid transportation pipe within a distance from the pivotable shaft of the flow regulating element. The distance is suitably selected such that the fixing element can project through a hole or a slot of the attachment component. The fixing element may comprise a screw and/or a bolt which is insertable in the slot of the attachment component or projects through a bore of the attachment component. Particularly, in case there is a slot, the fixing element is arranged approximately in the middle of the slot.

In a preferred embodiment the actuator system comprises a first attachment component connected to the first connecting port and a second attachment component connected to the second connecting port.

In a preferred embodiment of the present disclosure at least one of the fixing elements comprises: a shank portion extending through an opening formed in the attachment component, wherein the shank portion has an upper portion and a lower portion; a head portion formed at the upper portion of the shank, and a flexible support structure extending laterally (and possibly downwards) from the head portion to abut on a first surface of the attachment component; the lower portion has at least one flexible hook providing a barb-like structure. The flexible hooks extend laterally (and possibly upwards) from the lower portion of the shank. The inventive fixing element is claimed as a part of the actuator system, and it is claimed per se without being part of the actuator system, or as part of any other system that requires fixing of components.

In another preferred embodiment of the present disclosure, the actuator housing comprises: a first mechanical keying feature provided at the first longitudinal end of the housing; and a second mechanical keying feature provided at the second longitudinal end of the housing, the second mechanical keying feature being different from the first mechanical keying feature to prevent incorrect assembly of the attachment components; and wherein the at least one attachment component is selected from a set of interchangeable attachment components, the set comprising: the first attachment component is configured to connect exclusively to the first connecting port and comprising a third mechanical keying feature configured to mate with the first mechanical keying feature; and the second attachment component configured to connect exclusively to the second connecting port and comprising a fourth mechanical keying feature configured to mate with the second mechanical keying feature.

The term “keying feature” may be used synonymously with the term “code”. The mechanical keying feature may be, for example, a fitting combination of a nose and recess.

In a preferred embodiment of the present disclosure, the fixing element may comprise a sleeve which is attached to the screw and bolt, respectively. Providing a sleeve has the effect that the assembly process is improved. While, when there was an eccentricity caused by different diameters of the shaft and a clamp, the eccentricity could be compensated only by installing the anti-rotation device with play in the slot so that the system would not jam. This is error-prone and a relatively laborious assembly step. To simplify this assembly step, it is optimized by the sleeve with the pre-assembled screw so that this is much easier and no incorrect assembly is possible. As a result, a centric clamping block is no longer necessary. Furthermore, the sleeve helps when pre-mounting the fixing element as it functions as a spacer indicating how deep the fixing element may be fixed in the wall of the pipe.

It is preferred that the attachment component is provided for at least preventing rotation of the housing around an axis of rotation of the pivotable shaft.

In another embodiment of the present disclosure the attachment component is provided for allowing movement of the housing along a longitudinal axis of the fluid transportation pipe.

In another embodiment of the present disclosure the actuator system comprises at least two attachment components and the housing comprises at least two corresponding connecting ports. This embodiment is particularly useful if there is no eccentricity, e.g. due to the fact that the drive is mounted via a form-fit (positive locking) which does not lock the shaft in a vertical direction connection or via an interlock. Then the actuating motor only has to absorb the torque, but not any eccentricity. The interlock is virtually always central relative to the drive shaft of the shut-off flap. The housing of the actuating motor is screwed to the pipe and thus prevents the system from rotating with the shaft. Moreover, the actuating motor is secured in the axial direction of the drive shaft. No longitudinal play is required as for embodiments described above.

Furthermore, if eccentricity is no issue, both sides of the actuator may be equipped with an attachment component, particularly with the same kind, that are fixedly mounted to the pipe to prevent (longitudinal) axial play and rotation.

Another actuator system for operating a flow regulating element to regulate a fluid flow of a fluid transportation pipe according to the present disclosure comprises: an actuator having an actuating motor coupled to a pivotable shaft of the flow regulating element, and an actuator housing, wherein the actuating motor is connected to the actuator housing; and at least one attachment component for attachment of the actuator housing to a wall of the fluid transportation pipe/channel; wherein the actuator housing comprises at least one connecting port configured to connect the at least one attachment component to the actuator housing; wherein the at least one attachment component is configured to connect to the at least one connecting port by a first connection and a second connection, wherein the first connection comprises a positive fit connection between the at least one attachment component and the at least one connecting port, and the second connection comprises a clamping or snapping connection between the at least one attachment component and the at least one connecting port.

In a preferred embodiment of the present disclosure the positive fit connection is obtained by a relative axial movement of the actuator housing and the attachment component, wherein axial movement is a movement parallel or along the axis of rotation of the pivotable shaft.

The first connection may comprise at least one hook-like element having at least one of a longitudinal portion and an axial end portion extending upwardly, downwardly or laterally (extending inside or outside) from the first longitudinal portion.

The first connection may comprise at least an opening for insertion of the hook-like element, wherein the opening is provided in a side wall of the actuator housing.

In a preferred embodiment the first connection comprises two or more hook-like elements and a corresponding number of openings.

Instead of an opening in the side wall, the side wall may have a cavity formed in a wall portion of the side wall and extending from the opening, The cavity may have a longitudinal portion extending from the opening and an axial portion extending upwardly, downwardly or laterally (extending inside or outside) from the longitudinal portion.

The second connection may comprise a clamping or snapping element having a flexible arm and an engagement element for engagement in a corresponding engagement recess.

The second connection may comprise a corresponding engagement recess for engagement of the engagement element.

The engagement element(s) may be part of the attachment component, and the engagement recess(es) may be part of the connecting port, or vice versa.

Both the at least one attachment component and the at least one connecting port may have corresponding support surfaces which are in contact when the attachment component is connected to the connecting port of the housing. The support surfaces may be guiding surfaces while connecting the attachment component and the connecting port, and they may be stabilizing support surfaces after the connection has been accomplished.

In another preferred embodiment of the present disclosure the actuator housing may comprise: a first mechanical keying feature provided at the first longitudinal end of the housing; and a second mechanical keying feature provided at the second longitudinal end of the housing, the second mechanical keying feature being different from the first mechanical keying feature to prevent incorrect assembly of the attachment components; and wherein the at least one attachment component is selected from a set of interchangeable attachment components, the set comprising: the first attachment component configured to connect exclusively to the first connecting port and comprising a third mechanical keying feature configured to mate with the first mechanical keying feature; and the second attachment component configured to connect exclusively to the second connecting port and comprising a fourth mechanical keying feature configured to mate with the second mechanical keying feature.

Another actuator system for operating a flow regulating element to regulate a fluid flow of a fluid transportation pipe according to the present disclosure comprises: an actuator having an actuating motor coupled to a pivotable shaft of the flow regulating element, wherein the pivotable shaft has an axis of rotation, and an actuator housing, wherein the actuating motor is connected to the actuator housing; and at least one attachment component for attachment of the actuator housing to a wall of the fluid transportation pipe/channel; wherein the actuator housing comprises at least one connecting port configured to connect the at least one attachment component to the actuator housing; wherein the at least one attachment component is configured to connect to the at least one connecting port by a first connection comprising a positive fit connection between the at least one attachment component and the at least one connecting port, wherein the positive fit connection is provided by a relative axial movement of the actuator housing and the attachment component, and wherein axial movement is a movement parallel or along the axis of rotation of the pivotable shaft.

In a preferred embodiment of the present disclosure the first connection may comprise at least one hook-like element having at least one of a longitudinal portion and an axial end portion extending upwardly, downwardly or laterally (facing inside or outside) from the first longitudinal portion.

In a preferred embodiment of the present disclosure the first connection may comprise at least an opening for engagement of the hook-like element, wherein the opening is provided in a side wall of the actuator housing.

In another preferred embodiment of the present disclosure the at least one attachment component is configured to connect to the at least one connecting port by a second connection, wherein the second connection comprises a clamping or snapping connection between the at least one attachment component and the at least one connecting port.

The actuator housing may further comprise: a first mechanical keying feature provided at the first longitudinal end of the housing; and a second mechanical keying feature provided at the second longitudinal end of the housing, the second mechanical keying feature being different from the first mechanical keying feature to prevent incorrect assembly of the attachment components; and wherein the at least one attachment component is selected from a set of interchangeable attachment components, the set comprising: the first attachment component configured to connect exclusively to the first connecting port and comprising a third mechanical keying feature configured to mate with the first mechanical keying feature; and the second attachment component configured to connect exclusively to the second connecting port and comprising a fourth mechanical keying feature configured to mate with the second mechanical keying feature.

The object may also be achieved by providing a method for assembling an actuator system as described above, comprising the steps: pre-mounting the fixing element within a distance from the pivotable shaft, wherein the distance is adjusted such that, when the actuating motor is coupled to the pivotable shaft, the fixing element is positioned in the slot of the attachment component.

It is preferred that the fixing element is positioned substantially in the middle of the slot of the attachment component.

In a preferred embodiment of the present disclosure, the connecting port(s) and the respective attachment component(s) is/are pre-mounted, i.e. connected, before being delivered to an assembly site. For any of the described embodiments various options for any of the configuration may be possible, e.g.:
In a first option using both front-side and back-side attachment modules: This is required when axial fixation of the actuator is needed, typically for form-fit damper/valve to actuator interfaces that generally do not transmit axial forces to the actuator axis. In this case, no eccentric movement needs to be compensated (the longitudinal slots are theoretically not required, a simple hole would be sufficient).

In a second option using only the back-side attachment module: This is possible when the interface between the shaft and the actuator output inherently provides axial fixation.

Case 1: Eccentric clamping: The slot in the back-side module compensates for eccentricity. Typically, in this case the clamping axially fixes the damper to the actuator.

Case 2: Centric clamping: No compensation of axial movement through the slot is required. Here as well, the clamping axially fixes the damper to the actuator.

Option 3: The front-side and back-side attachment modules share a similar mechanical interface, with mechanical keying to prevent incorrect assembly.

Option 4: The mounting direction of the attachment modules is parallel to the actuator axes. Two highly torque stable guide elements ensure a broad mechanical support. Two snap in features provide axial fixation.

Option 5: An extended longitudinal design of the back side (rear side, second) attachment module enables higher torque transmission (various lengths available).

The present disclosure relates to any combination of any features and options described in this application.

### BRIEF DESCRIPTION OF THE DRAWINGS

The present disclosure will be explained in greater detail with reference to the exemplary embodiments which are illustrated in the drawings.

FIG. 1 is a perspective view of a first embodiment of an actuator system according to the present disclosure in a mounted state;

FIG. 2 is a perspective view of a detail of the first embodiment of the present disclosure in an unmounted state;

FIG. 3 is a top sectional view of a detail the first embodiment of the present disclosure in a mounted state;

FIG. 4 is a perspective view of a detail of a second embodiment of the present disclosure in an unmounted state;

FIG. 5 is a top sectional view of a detail of a second embodiment of the present disclosure in a mounted state;

FIG. 6 is a perspective view of the second embodiment of the present disclosure in a mounted state; and

FIG. 7 illustrates perspective views of a component of a third embodiment of the present disclosure.

FIG. 8 is a perspective view of an actuator housing of a fourth embodiment of an actuator system according to the present disclosure;

FIG. 9 is a perspective view of a first end portion of the actuator housing of the fourth embodiment;

FIG. 10 is a perspective view of a second end portion of the actuator housing of the fourth embodiment;

FIG. 11 is a perspective view of the actuator system of the fourth embodiment;

FIG. 12 is a bottom perspective view of the actuator system of the fourth embodiment;

FIG. 13 is a perspective view of a first attachment component of the actuator system of the fourth embodiment;

FIG. 14 is a partial view of the actuator system of the fourth embodiment showing the first attachment component;

FIG. 15 is a perspective view of a second attachment component of the actuator system of the fourth embodiment;

FIG. 16 is a partial view of the actuator system of the fourth embodiment showing the second attachment component;

FIG. 17 is a perspective view of another embodiment of an attachment component according to the present disclosure;

FIG. 18 is a side view of a fixing element according to the present disclosure.

### DETAILED DESCRIPTION

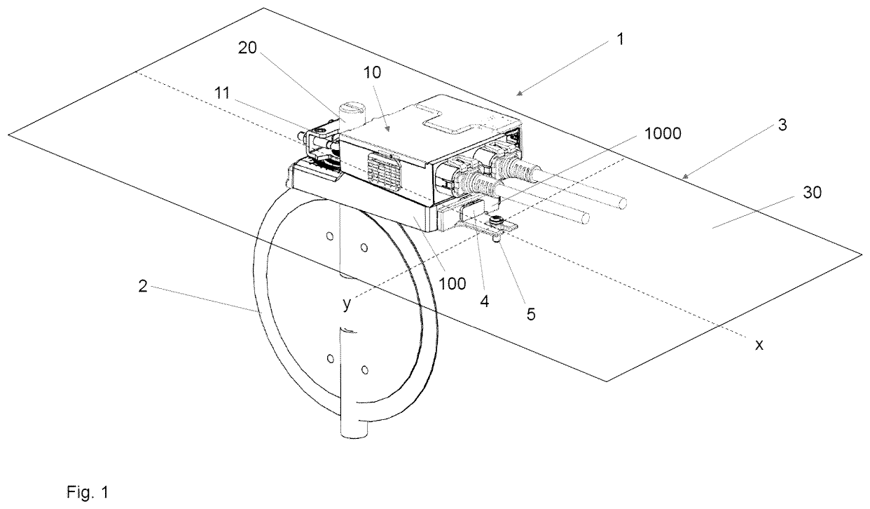

FIG. 1 illustrates a first embodiment of an actuator system 1 according to the present disclosure for operating a flow regulating element, e. g. a flap or a valve shutter 2 (implied in the drawing, although not visible), for regulating a fluid flow in a fluid transportation pipe 3. In this embodiment the transportation pipe 3 forms an air flow channel.

The actuator system 1 comprises an actuator 10 having an actuating motor coupled to a pivotable shaft 20 of the flow regulating element 2 which projects from the wall 30 of the pipe 3. The actuating motor may have a step-down gear mechanism to rotate the shaft 20 exactly in a predefined angle. The coupling can e. g. be accomplished via a positive or a non-positive fit, e. g. by clamping. The actuator 10 has an actuator housing 100, wherein the actuating motor is accommodated.

Furthermore, the actuator system 1 comprises an attachment component 4 for attachment of the attachment component 4 to a wall 30 of the fluid transportation pipe 3. The actuator housing 100 comprises a connecting port 1000 for connecting the attachment component 4 to the housing 100. The actuator 10 and the attachment component 4 are configured as modular system 1.

The regulating element 2 is arranged within the pipe 3. It is connected or formed integrally with a shaft 20 that extends through the wall 30 of the pipe 3. The shaft 20 is fixed to and coupled with the motor of the actuator 10 such that the actuator 10 is capable of rotating the shaft 20. The motor may be axially coupled with the shaft 20 by a clamping connection 11. However, this connection may not be perfectly axial, but it may have an eccentricity which depends on the shaft diameter, when the shaft 20 is fixed by a universal clamping connection 11 suitable for fixing various shaft diameters. Therefore, the housing may move along a longitudinal axis x of the pipe 3 when the shaft 20 is rotated by the motor of the actuator 10.

The attachment component 4 is attached to the housing 100 via the connecting port 1000, and it is connected to the wall 30 of the pipe 3 by means of a self-tapping screw 5.

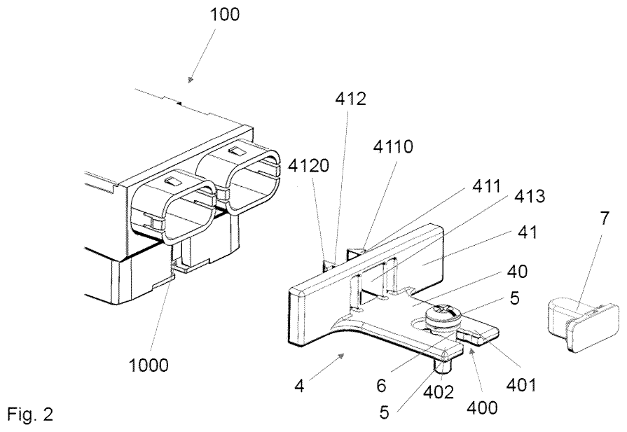

FIG. 2 illustrates details of the attachment component 4 of the first embodiment of the present disclosure and of the connection between the attachment component 4 and the housing 100.

The attachment component 4 is made of plastics, but it could be made of any other suitable material like sheet metal. It has a first connection portion 40 for connecting to the wall 30 of the pipe 3. The first connection portion 40 is arranged on the surface of the wall 30 of the pipe 3. In a mounting process a screw 5 may be screwed in the wall 30 of the pipe 3 before the actuator system 1 is fixed to the pipe 3, or the screw may be fixed to the wall 30 after arranging the actuator system 1. Thus the system 1 can be mounted to the pipe 3 by a person using just one hand.

The screw 5 is provided with a sleeve 6 which is attached to the screw 5. The sleeve 6 has the function of a spacer. It delimits the depth of screwing the screw 5 into the pipe 3 and prevents that the screw 5 is screwed in too deep.

The first connection portion 40 has a longitudinal slot 400 formed therein. The shaft 50 of the pre-fixed screw 5 extends through the slot 400. The slot 400 is defined by a first arm 401 of the first connection portion 40 and a second arm 402 of the first connection portion 40. The screw 5 is arranged about in the middle of the x-extension of the slot 400 (see FIG. 1). This arrangement allows the attachment component 4 to move relative to the pipe 3 along a longitudinal axis x.

The second connection portion 41 of the attachment component 4 is provided for attaching the component 4 to the housing 100 of the actuator 10. Therefore, the second connection portion 41 comprises a body 410 which extends in an angle of about 90° from the first connection portion 40, and two engagement arms 411 and 412 for engagement with the connecting port 1000 provided in the housing 100. The arms 411 and 412 extend parallel to and to the opposite side of the first connection portion 41. The arms 411 and 412 are at least partially elastic and have an outwardly extending engagement protrusion 4110 and 4120 for engagement with corresponding recesses (not shown) formed in the connection port 1000.

When mounting the system 1 to the pipe 3, the screw 5 carrying the sleeve 6 is screwed into the wall 30 of the pipe 3. Afterwards, the slot 400 of the attachment component 4 is fixed to the screw by pushing the attachment component 4 such that the screw 5 is inserted into the slot 400. When the attachment component 4 is in the correct position, the actuator housing 100 is connected to the attachment component 4 by inserting the engagement arms 411 and 412 of the attachment component 4 into the connection port 1000 of the housing of the actuator 10. Afterwards, a locking element 7 may be inserted through an opening 413 formed in the body 410 of the second connection portion 41 between the arms 411 and 412. The locking element 7 blocks the arms 411 and 412 and prevents the attachment component 4 from disengaging from the connection port 1000.

The steps of fixing the attachment component 4 to the housing 100 and the pipe 3, respectively, can be carried out in different order.

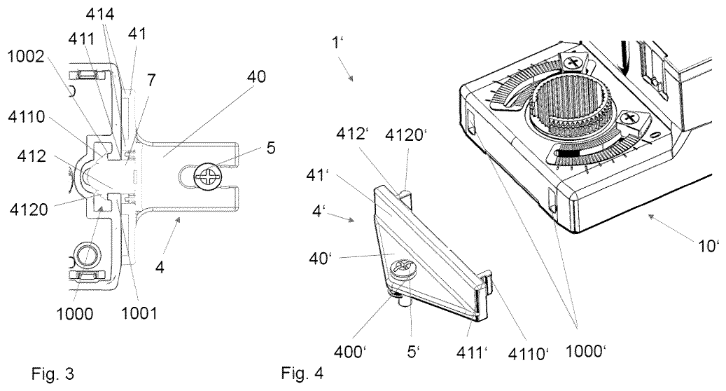

FIG. 3 is a sectional top view of the connection between the housing 100 and the attachment component 4, wherein the same reference numbers are used. In this view it can be seen that the attachment component comprises support protrusions 414 (two of them being marked exemplary) for supporting the attachment component 4 in a correct position relative to the housing 100. Furthermore, the recesses 1001 and 1002 for engagement of the engagement protrusions (latching lugs) 4110 and 4120, and the blocking function of the locking element 7 can be seen.

The attachment component 4 and the screw 5 align and keep the actuator 10 in a predetermined longitudinal orientation, i. e. rotation of the actuator 10 in a plane x-y (see FIG. 1) and/or rotation of the actuator 10 around the shaft 20 of the regulating element 2 is prevented, while compensating eccentric alignment of the shaft 20 relative to the actuator 10. In fact, any eccentricity caused by the fit between the actuator motor and the shaft 20 can be compensated for without problems at any time when the drive shaft 20 is rotated.

FIG. 4 illustrates a second embodiment of the modular system 1′ of the present disclosure. Corresponding components have the same reference numbers with apostrophe as in the first embodiment.

FIG. 4 shows a detail of the system 1′ having an actuator 10′ and two attachment components 4′ (only one attachment component is shown in FIG. 4), one for each side of the actuator 10′. In this embodiment the shaft is only coupled to transfer the rotary movement, but the system 1 is not fixed to the duct/shaft 3 along the shaft axis (e.g. by clamping) like in the first embodiment, thus two attachment components are needed.

The actuator 10′ comprises a connection port 1000′ for engagement of engagement arms 411′ and 412′ of the attachment component 4′. The attachment component 4′ differs from the attachment component 4 of the first embodiment in that it does not comprise a slot formed in the first connection portion 40′, but a through hole 400′ for insertion of a screw 5′.

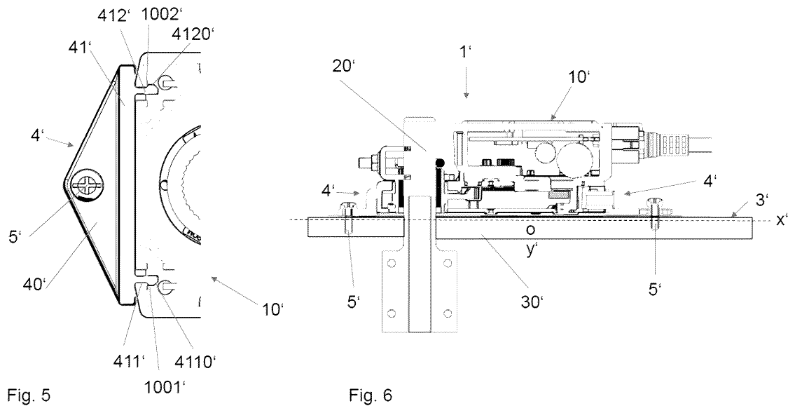

FIG. 5 is a sectional top view of the second embodiment of the present disclosure in a mounted state with engagement protrusions 4110′ and 4120′ engaging the recesses 1001′ and 1002′, respectively, of the connection port 1000′.

FIG. 6 is a longitudinal sectional view of the complete system 1′ of the second embodiment mounted to the wall 30′ of a pipe 3′. The drawing shows that the actuator 10′ is mounted to the pipe 3′ at each of the longitudinal ends by a respective attachment component 4′ which are fixed to the wall 30′ of the pipe 3′ by respective screws 5′. It can be seen that the actuator 10′ is not moveable along the axis x′, i. e. the system 1′ is provided for the case that no eccentricity occurs that has to be compensated when the shaft 20′ of the regulating element is rotated. The system 1′ is fixed to the pipe 3′ in at least x′ and y′ extension.

Assembling an actuator system 1 or 1′ of any of the embodiments includes pre-mounting the fixing element 5, 5′ in a predetermined distance from the pivotable shaft 20, 20′, wherein the distance is adjusted such that, when the actuating motor is coupled to the pivotable shaft 20, 20′, the fixing element 5, 5′ engages the slot 400 and through hole 400′, respectively, of the attachment component 4, 4′.

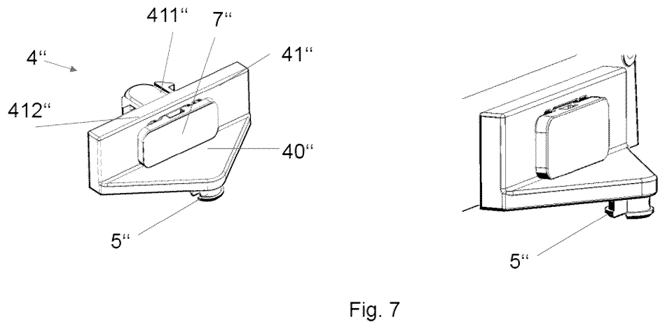

FIG. 7 refers to a third embodiment of the attachment component 4″. Compared to the first and the second embodiments the attachment component 4″ comprises, instead of a through hole for a screw, a spring element 5″ or an attachment protrusion which extends from the bottom surface (facing the pipe) of the first connection portion 40″. When fixing the attachment component 4″ to the pipe, the spring element or attachment protrusion 5″ is latched, inserted or engaged in a corresponding blind hole (not shown) formed in the wall of the pipe. Furthermore, attachment component 4″ has a locking element 7″ for locking the attachment component 4″ to the housing of the actuator, similar to the first embodiment.

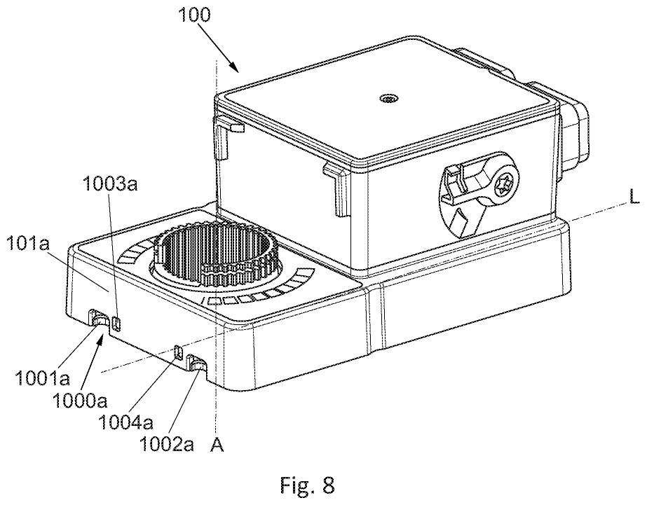

FIGS. 8 to 16 refer to a fourth embodiment of an actuator system 1 according to the present disclosure. The same reference numerals as in the previous description are used for corresponding components. A longitudinal axis is designated L, an axial direction is designated A.

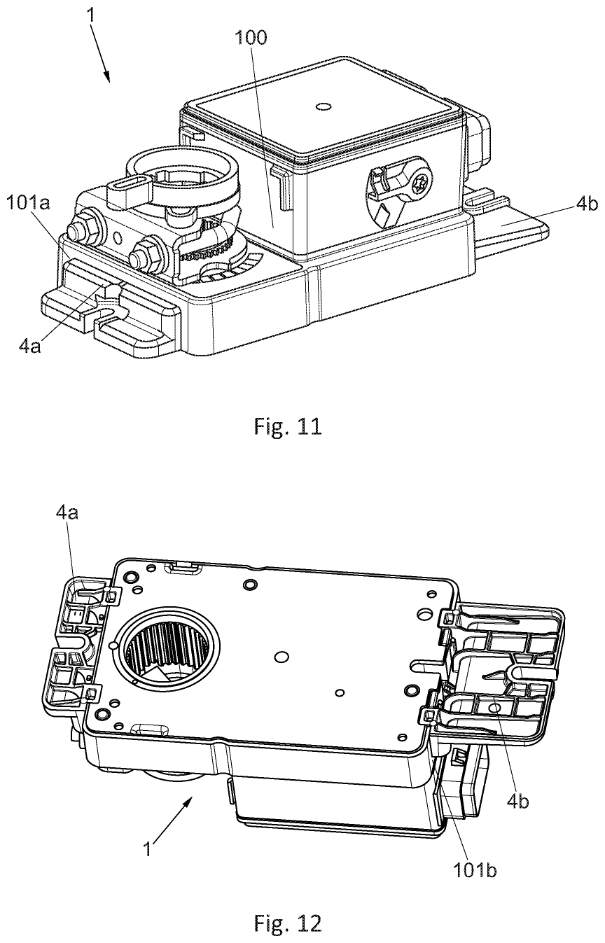

FIG. 8 illustrates an actuator housing 100. The actuator housing 100 comprises a first connecting port 1000a arranged at a first longitudinal end of the housing 100. The first connecting port 1000a comprises two openings 1001a and 1002a provided in the first end wall 101a of the housing 100. The openings 1001a, 1002a are part of a positive fit connection with a corresponding first attachment component 4a (see FIGS. 11, 12).

Furthermore, the first connecting port 1000a comprises two recesses 1003a and 1004a provided in the first end wall 101a of the housing 100 forming part of a snapping connection with the corresponding first attachment component 4a (see FIGS. 11, 12).

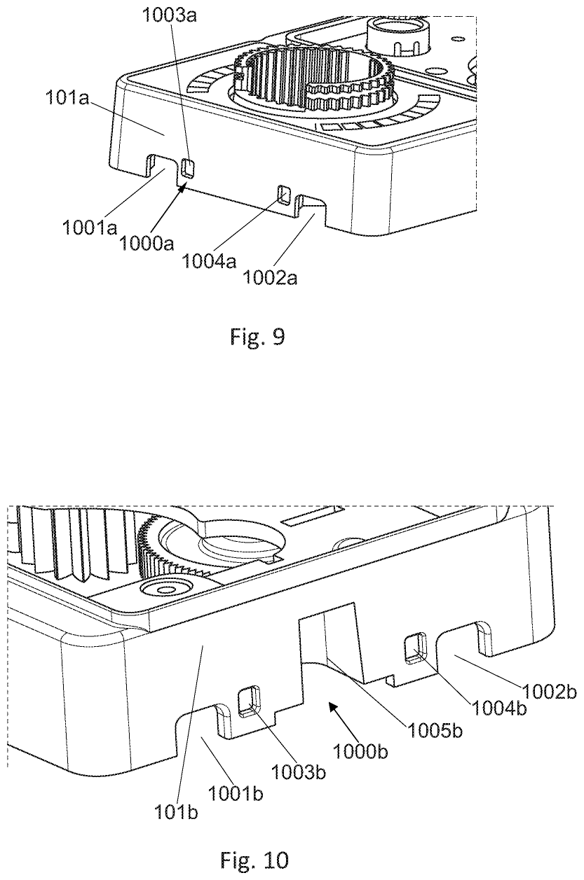

FIG. 9 illustrates an enlarged view of the first longitudinal end portion of the housing 100.

FIG. 10 illustrates an enlarged view of the second longitudinal end portion of the housing 100 which is arranged opposite the first longitudinal end portion. The second longitudinal end portion comprises a second connecting port 1000b. The second connecting port 1000b comprises two openings 1001b and 1002b provided in the second end wall 101b of the housing 100 forming part of a positive fit connection with a corresponding second attachment component 4b (see FIGS. 11, 12). Furthermore, the second connecting port 1000b comprises two recesses 1003b and 1004b provided in the second end wall 101b of the housing 100 forming part of a snapping connection with the corresponding second attachment component 4b (see FIGS. 11, 12). Furthermore, the second connecting port 1000b comprises a third central recess 1005b.

FIGS. 11 and 12 are top and bottom perspective views, respectively, of the actuator system of the fourth embodiment with a first attachment component 4a mounted to the first connecting port 1000a via a positive fit connection, and a second attachment component 4b mounted to the second connecting port 1000b via a snapping connection.

The actuator 10 and the attachment components 4a, 4b are configured as modular system 1. The attachment components 4a and 4b may be different modules with differing distances of the slot from the axis when being mounted.

The attachment components 4a, 4b are attached to the housing 100 via respective connecting ports 1000a and 1000b.

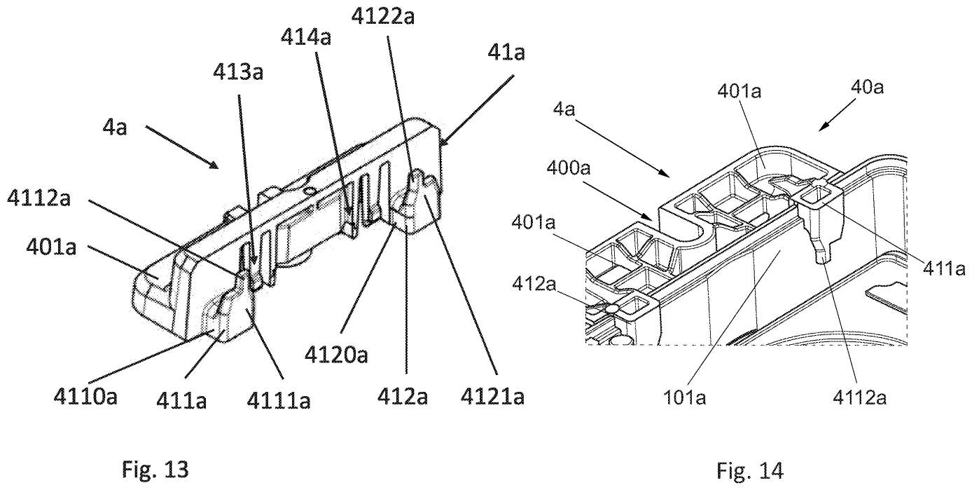

FIGS. 13 and 14 show details of the first attachment component 4a in a de-mounted state and in a state mounted to the housing 100, respectively.

The first attachment component 4a comprises a first connection portion 40a for connecting to a wall 30 of a pipe 3. The first connection portion 40a may be arranged on the surface of the wall of the pipe. In a mounting process a fixing element may be screwed in the wall of the pipe before the actuator system 1 is fixed to the pipe, or the screw may be fixed to the wall after arranging the actuator system 1.

The first connection portion 40a has a longitudinal slot 400a formed therein. The slot 400a is defined by a first arm 401a of the first connection portion 40a and a second arm 402a of the first connection portion 40a.

The second connection portion 41a of the first attachment component 4a is provided for attaching the component 4a to the first end wall 101a of the housing 100 of the actuator 10. Therefore, the second connection portion 41a comprises a wall 410a which extends in an angle of about 90° from the first connection portion 40a, and two hook-like elements 411a and 412a for engagement with the first connecting port 1000a. The hook-like elements 411a and 412a each have a longitudinal portion 4110a, 4120a extending towards and through the openings 1001a and 1002a. Furthermore, the hook-like elements 411a and 412a each have an axially orientated portion 4111a, 4121a extending perpendicularly upwards from the end of the respective longitudinal portion 4110a, 4120a, defining a gap between the wall 410a of the second connection portion 41a and the axially orientated portions 4111a, 4121a of the hook-like elements 411a and 412a. In a mounted state of the first attachment component 4a the gap receives a part of the first end wall 101a of the housing 100.

Each of the axially orientated portions 4111a, 4121a has a protruding nose 4112a, 4122a and therefore cannot be installed to the second connecting port 1000b, since the second connecting port 1000b would block the protruding noses 4112a, 4122a when trying to insert the hook-like elements 411a and 412a into openings 1001b and 1002b of the second connecting port 1000b.

Furthermore, for axial locking of the first attachment component 4a to the housing 100 the first attachment component 4a includes two elastic snapper arms 413a and 414a, each of them comprising a respective engagement protrusion at the end thereof for engagement with recesses 1003a and 1004a, respectively, provided in the first end wall 101a of the housing 100.

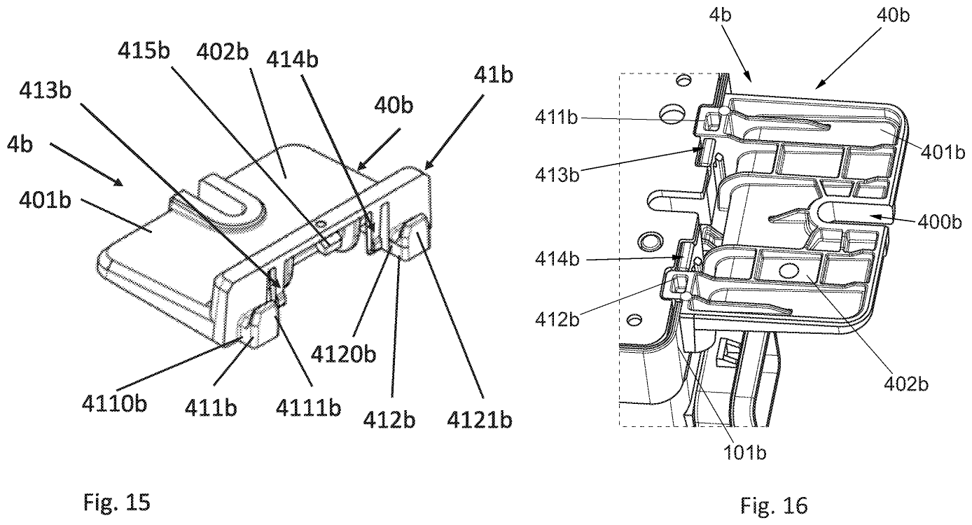

FIGS. 15 and 16 show details of the second attachment component 4b in a de-mounted state and in a state mounted to the housing 100, respectively.

The second attachment component 4b comprises a first connection portion 40b for connecting to a wall of a pipe. The first connection portion 40b of the second attachment component 4b may be arranged on the surface of the wall of the pipe. In a mounting process a fixing element may be screwed in the wall of the pipe before the actuator system 1 is fixed to the pipe, or the screw may be fixed to the wall after arranging the actuator system 1.

The first connection portion 40b has a longitudinal slot 400b formed therein. The slot 400b is defined by a first arm 401b of the first connection portion 40b and a second arm 402b of the first connection portion 40b.

The second connection portion 41b of the second attachment component 4b is provided for attaching the component 4b to the second end wall 101b of the housing 100 of the actuator 10 which is at the opposite side to the first end wall 101a of the housing 100. Therefore, the second connection portion 41b comprises a wall 410b which extends in an angle of about 90° from the first connection portion 40b, and two hook-like elements 411b and 412b for engagement with the second connecting port 1000b provided in the housing 100. The hook-like elements 411b and 412b each have a longitudinal portion 4110b, 4120b extending towards and through the openings 1001b and 1002b. Furthermore, the hook-like elements 411b and 412b each have an axially orientated portion 4111b, 4121b extending perpendicularly upwards from the end of the respective longitudinal portion 4110b, 4120b, defining a gap between the wall 410b of the second connection portion 41b and the axially orientated portions 4111b, 4121b of the hook-like elements 411b and 412b. In a mounted state of the first attachment component 4b the gap receives a part of the second end wall 101b of the housing 100.

Furthermore, for axial locking of the second attachment component 4b to the housing 100 the second attachment component 4b includes two elastic snapper arms 413b and 414b, each of them comprising a respective engagement protrusion at the end thereof for engagement with recesses 1003b and 1004b, respectively, provided in the second end wall 101b of the housing 100.

Furthermore, the second connection portion 41b of the second attachment component 4b comprises a coding protrusion 415b (mechanical keying feature) extending longitudinally towards the second end wall 101b, and, in a mounted state of the second attachment component 4b to the housing 100, engages with the third central recess 1005b of the housing 100. The protrusion 115b prevents the second attachment component 4b from being mounted to the first connection port 1000a of the housing 100.

In other embodiments of the present disclosure the keying features may be omitted so the attachment modules may be mounted to either of the connecting ports.

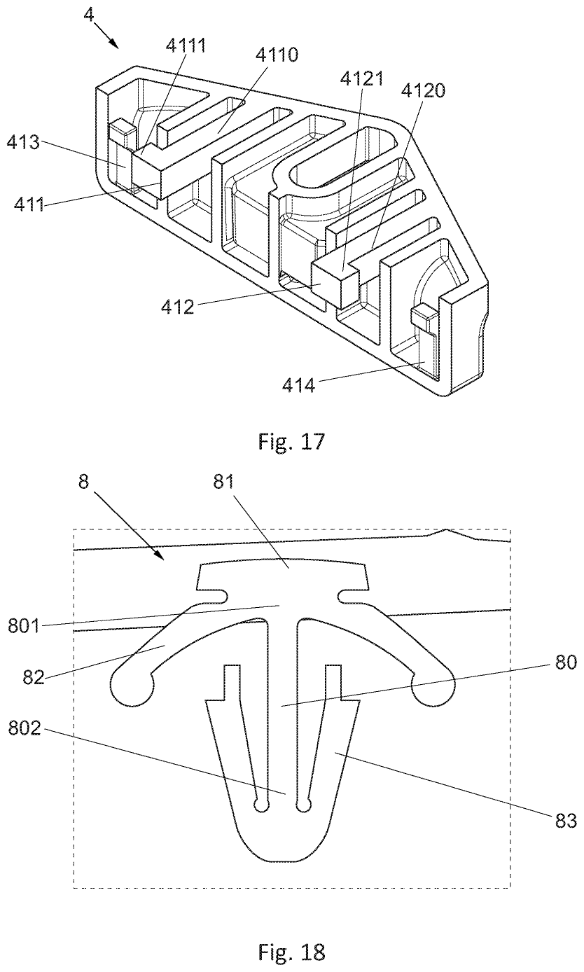

FIG. 17is a perspective view of another embodiment of an attachment component 4 according to the present disclosure. The same reference numerals as in previous embodiments refer to corresponding components of the embodiment.

The attachment component 4 has two hook-like elements 411 and 412 for engagement with one of the first and second connecting port of a housing as described above. The hook-like elements 411 and 412 each have a longitudinal portion 4110, 4120 extending longitudinally. Furthermore, the hook-like elements 411 and 412 each have a portion 4111, 4121 extending (perpendicularly) laterally (outwardly) from the end of the respective longitudinal portion 4110, 4120. Together with corresponding recesses, cavities and openings, respectively, in the connecting port the hook-like elements 411 and 412 form a positive fit connection with the housing.

Furthermore, the attachment component includes two elastic snapper arms 413 and 414, each of them comprising a respective engagement protrusion at the end thereof for engagement with recesses provided in an end wall of a housing.

FIG. 18 is a side view of a new fixing element 8 according to the present disclosure. The fixing element 8 includes a shank portion 80 for extending through an opening formed in any of the attachment components 4, 4′, 4″, 4a, 4b, wherein the shank portion 80 has an upper portion 801 and a lower portion 802. At the upper portion 801 of the shank 80 a head portion 81 and a flexible support structure 82 extending laterally and/or downwards from the upper portion 801 to abut on a first surface of an attachment component are formed. Furthermore, at least one flexible hook 83 or hook structure providing a barb-like structure extends laterally and/or upwards from the lower portion 802 of the shank 80. The at least one flexible hook 83 or hook structure fixes the fixing element 8 e.g. in a bore. The flexible support structure 82 and the at least one flexible hook 83 or hook structure provide an axial fixation in both upward and downward direction when the fixing element is mounted.

The fixing element may be used in any other application, particularly on applications of the actuator system, in which the attachment elements are not designed as modules but are part of the actuator housing.

1. An actuator system for operating a flow regulating element to regulate a fluid flow of a fluid transportation pipe, the actuator system comprising:
an actuator having an actuating motor coupled to a pivotable shaft of the flow regulating element, and an actuator housing having a first longitudinal end and an opposite second longitudinal end, wherein the actuating motor is connected to the actuator housing; and
at least one attachment component for attachment of the actuator housing to a wall of the fluid transportation pipe, wherein the attachment component is selected from a set of attachment components, the set comprising a first attachment component and a second attachment component;
wherein the actuator housing comprises a first connecting port at the first longitudinal end and a second connecting port at the second longitudinal end, the first connecting port being configured to connect the first attachment component and the second connecting port to connect the second attachment component to the housing by a clamping connection comprising two flexible arms configured to be inserted in corresponding receptacles of the connecting ports; and
wherein the least one attachment component is arranged at one of the opposite longitudinal ends of the actuator housing preventing rotation of actuator housing around an axis of the pivotable shaft and a longitudinal movement along the axis.

2. The actuator system according to claim 1, wherein the actuator system is a modular system comprising the actuator and the first and the second attachment component.

3. The actuator system according to claim 1, wherein the at least one attachment component is detachably fixable to a respective connection port of the actuator housing.

4. The actuator system according to claim 1, wherein the at least one attachment component comprises a slot configured to receive a respective fixing element which is fixed in the wall of the fluid transportation pipe.

5. The actuator system of claim 4, wherein the at least one fixing element comprises:
a shank extending through an opening formed in the attachment component, wherein the shank has an upper portion and a lower portion;
a head portion formed at the upper portion of the shank, and a flexible support structure extending laterally from the upper portion to abut on a first surface of the attachment component;
wherein at least one flexible hook providing a barb-like structure extends from the lower portion.

6. The actuator system of claim 1, comprising a first attachment component connected to the first connecting port and a second attachment component connected to the second connecting port.

7. The actuator system of claim 1, wherein the actuator housing comprises:
a first mechanical keying feature provided at the first longitudinal end of the housing; and
a second mechanical keying feature provided at the second longitudinal end of the housing, the second mechanical keying feature being different from the first mechanical keying feature to prevent incorrect assembly of the attachment components; and
wherein the at least one attachment component is selected from a set of interchangeable attachment components, the set comprising:
the first attachment component configured to connect exclusively to the first connecting port and comprising a third mechanical keying feature configured to mate with the first mechanical keying feature; and
the second attachment component configured to connect exclusively to the second connecting port and comprising a fourth mechanical keying feature configured to mate with the second mechanical keying feature.

8. An actuator system for operating a flow regulating element to regulate a fluid flow of a fluid transportation pipe, the actuator system comprising:
an actuator having an actuating motor coupled to a pivotable shaft of the flow regulating element, and an actuator housing, wherein the actuating motor is connected to the actuator housing; and
at least one attachment component for attachment of the actuator housing to a wall of the fluid transportation pipe;
wherein the actuator housing comprises at least one connecting port configured to connect the at least one attachment component to the actuator housing;
wherein the at least one attachment component is configured to connect to the at least one connecting port by a first connection and a second connection, wherein the first connection comprises a positive fit connection between the at least one attachment component and the at least one connecting port, and the second connection comprises a clamping or snapping connection between the at least one attachment component and the at least one connecting port.

9. The actuator system of claim 8, wherein
the positive fit connection is provided by a relative axial movement of the actuator housing and the attachment component, wherein axial movement is a movement parallel or along the axis of rotation of the pivotable shaft.

10. The actuator system of claim 8, wherein
the first connection comprises at least one hook-like element having at least a first longitudinal portion and an axial end portion extending upwardly, downwardly or laterally (facing inside or outside) from the first longitudinal portion.

11. The actuator system of claim 10, wherein
the first connection comprises at least an opening for insertion of the hook-like element, wherein the opening is provided in a side wall of the actuator housing.

12. The actuator system of claim 8, wherein
the second connection comprises a clamping or snapping element having a flexible arm and an engagement element for engagement in a corresponding engagement recess.

13. The actuator system of claim 12, wherein
the second connection comprises an engagement recess for engagement of the engagement element.

14. The actuator system of claim 8, wherein both the at least one attachment component and the at least one connecting port have corresponding support surfaces which are in contact when the attachment component is connected to the connecting port of the housing.

15. The actuator system of claim 8, wherein the actuator housing comprises:
a first mechanical keying feature provided at a first longitudinal end of the housing; and
a second mechanical keying feature provided at a second longitudinal end of the housing, the second mechanical keying feature being different from the first mechanical keying feature to prevent incorrect assembly of the attachment components; and
wherein the at least one attachment component is selected from a set of interchangeable attachment components, the set comprising:
a first attachment component configured to connect exclusively to the first connecting port and comprising a third mechanical keying feature configured to mate with the first mechanical keying feature; and
a second attachment component configured to connect exclusively to the second connecting port and comprising a fourth mechanical keying feature configured to mate with the second mechanical keying feature.

16. An actuator system for operating a flow regulating element to regulate a fluid flow of a fluid transportation pipe, the actuator system comprising:
an actuator having an actuating motor coupled to a pivotable shaft of the flow regulating element, wherein the pivotable shaft has an axis of rotation, and an actuator housing, wherein the actuating motor is connected to the actuator housing; and
at least one attachment component for attachment of the actuator housing to a wall of the fluid transportation pipe;
wherein the actuator housing comprises at least one connecting port configured to connect the at least one attachment component to the actuator housing;
wherein the at least one attachment component is configured to connect to the at least one connecting port by a first connection comprising a positive fit connection between the at least one attachment component and the at least one connecting port, and
wherein the positive fit connection is provided by a relative axial movement of the actuator housing and the attachment component, wherein axial movement is a movement parallel or along the axis of rotation of the pivotable shaft.

17. The actuator system of claim 16, wherein
the first connection comprises at least one hook-like element having at least a first longitudinal portion and an axial end portion extending upwardly, downwardly or laterally (facing inside or outside) from the first longitudinal portion.

18. The actuator system of claim 16, wherein
the first connection comprises at least an opening for engagement of the hook-like element, wherein the opening is provided in a side wall of the actuator housing.

19. The actuator system of claim 16, wherein
the at least one attachment component is configured to connect to the at least one connecting port by a second connection, wherein the second connection comprises a clamping or snapping connection between the at least one attachment component and the at least one connecting port.

20. The actuator system of claim 16, wherein the actuator housing comprises: the actuator housing comprises:
a first mechanical keying feature provided at a first longitudinal end of the housing; and
a second mechanical keying feature provided at a second longitudinal end of the housing, the second mechanical keying feature being different from the first mechanical keying feature to prevent incorrect assembly of the attachment components; and
wherein the at least one attachment component is selected from a set of interchangeable attachment components, the set comprising:
a first attachment component configured to connect exclusively to the first connecting port and comprising a third mechanical keying feature configured to mate with the first mechanical keying feature; and
a second attachment component configured to connect exclusively to the second connecting port and comprising a fourth mechanical keying feature configured to mate with the second mechanical keying feature.
